(19) United States
(12) Patent Application Publication
(10) Pub. No.: US 2005/0070224 A1
(43) Pub. Date: Mar. 31, 2005

(54) Method of using external electronic device on fixed platform to operate short messages through mobile communication device

(75) Inventors: Tai-Shui Ho, Taipei Hsien (TW); Shih-Kuang Tsai, Taipei Hsien (TW); Peng Gao, Shanghai City (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei Hsien (TW)

(21) Appl. No.: 10/671,579

(22) Filed: Sep. 29, 2003

(51) Int. Cl. H04M 1/00; H04B 1/38

(52) U.S. Cl. 455/41.2; 455/557

(57) ABSTRACT

This invention discloses a method of editing a short message through a fixed platform of a PC being connected to a mobile phone via a cable or wireless (such as infrared) transmission, so that when a user presses the “SEND” button, the short message will go through a string mode coding in PDU format, and then the personal computer will send a command “AT+CMGS” and the string mode code in PDU format to the mobile phone. After the command “AT+CMGS” being received, the short message is sent out according to the address, mobile phone number, and way of sending specified in the string mode code in PDU format to complete the process of sending a short message, enabling a user to utilize the powerful data processing capability of the personal computer to edit the text of the short message conveniently.

### BACKGROUND OF THE INVENTION

1. Field of the Invention

The present invention relates to a method of operating short messages through a mobile communication device, more particularly to the method of using an external electronic device on a fixed platform to operate short messages through a mobile communication device.

2. Description of the Related Art

Since it is a world of electronic information and has fast development on various industries, the information flow is very fast, and the demand for information and its exchange are getting larger and larger. Therefore, Internet has been widely used in many different industries, and a mobile communication device (such as a mobile phone) is now in widespread use and becomes an indispensable part of our daily life.

As mobile communication devices particularly mobile phones become very popular and extensively used by users, it is known to most users that sending short messages (including SMS, MMS, and EMS message service) from a mobile phone is very convenient and cheap, and it also has the advantages of high usage rate of bandwidth, excellent protection for confidentiality, and powerful interference resistance. Although it is very convenient to send and receive short messages through a mobile phone, there are limitations on entering the short message since the size of the mobile phone is too small, and the distance between keys and the size of each key are very small as well. It is relatively troublesome for a user to operate, edit, and send a short message, particularly for users other than those using Latin language, users have to repeat operating the keys for many times to enter a short message.

Even if manufacturers had measures to simplify the entering process, users still have to press the keys for several tens or even hundreds of times in a very limited space of the mobile phone in order to send a short message. Such arrangement not only causes inconvenience to users, but also affects the speed on user's operation of the short messages, and thus causing a great deal of inconvenience.

However, the inventor believes that most of the time, it is not necessary for a user to edit a short message on the mobile state. In other words, in most of the circumstances, a user rather sacrifices the mobility of the mobile phone for the convenience of editing a short message. This invention focused on the above shortcomings to perform research and overcome the shortcomings of the traditional prior art.

### SUMMARY OF THE INVENTION

In view of the description above, there are many shortcomings when users edit and send short messages through a mobile phone, the inventor of the present invention based on years of practical experience engaging in the related industry to conducted research and experiments, and finally invented this invention. This invention uses an external electronic device (such as a personal computer, PC) on a fixed platform to edit a short message, and then sends out the short message through a mobile communication device (such as a mobile phone) which is connected to the external electronic device via network. Leveraging the convenience of editing text on a personal computer can compensate the insufficiency of operating and entering short messages through a mobile phone.

The primary objective of the present invention is to provide a method of editing a short message through a fixed platform of a PC being connected to a mobile phone via a cable or wireless (such as infrared) transmission method, so that when a user presses the “SEND” button, the short message will go through a string mode coding in PDU format, and then the personal computer will send a command “AT+CMGS” and the string mode code in PDU format to the mobile phone. After the mobile phone has received the command “AT+CMGS”, the short message is sent out according to the address, mobile phone number, and way of sending specified in the string mode code in PDU format to complete the process of sending a short message for one time. The powerful data processing capability and the convenient way of editing text of the personal computer are used to compensate the insufficiency of operating and entering a short message through mobile phone.

### BRIEF DESCRIPTION OF THE DRAWINGS

Other features and advantages of the present invention will become apparent in the following detailed description of the preferred embodiments with reference to the accompanying drawing.

FIG. 1 is an illustrative diagram of the hardware structure of the present invention.

FIG. 2 is another illustrative diagram of the hardware structure of the present invention.

FIG. 3 is a flow chart of the present invention.

FIG. 4 is an illustrative diagram of the address of the SMSC.

FIG. 5 is an illustrative diagram of the transport protocol data unit (TPDU).

### DETAILED DESCRIPTION OF THE PREFERRED EMBODIMENTS

Since sending a short message through a mobile phone has many advantages including its convenient use, low price, and the like, therefore it is extensively used among the public. However, the size of a mobile phone is too small, and the distance between keys and the size of each key are small, too, and thus causing many limitations on operating and entering a short message. It will affect the speed of user's operation on short messages, and thus causing a great deal of inconvenience.

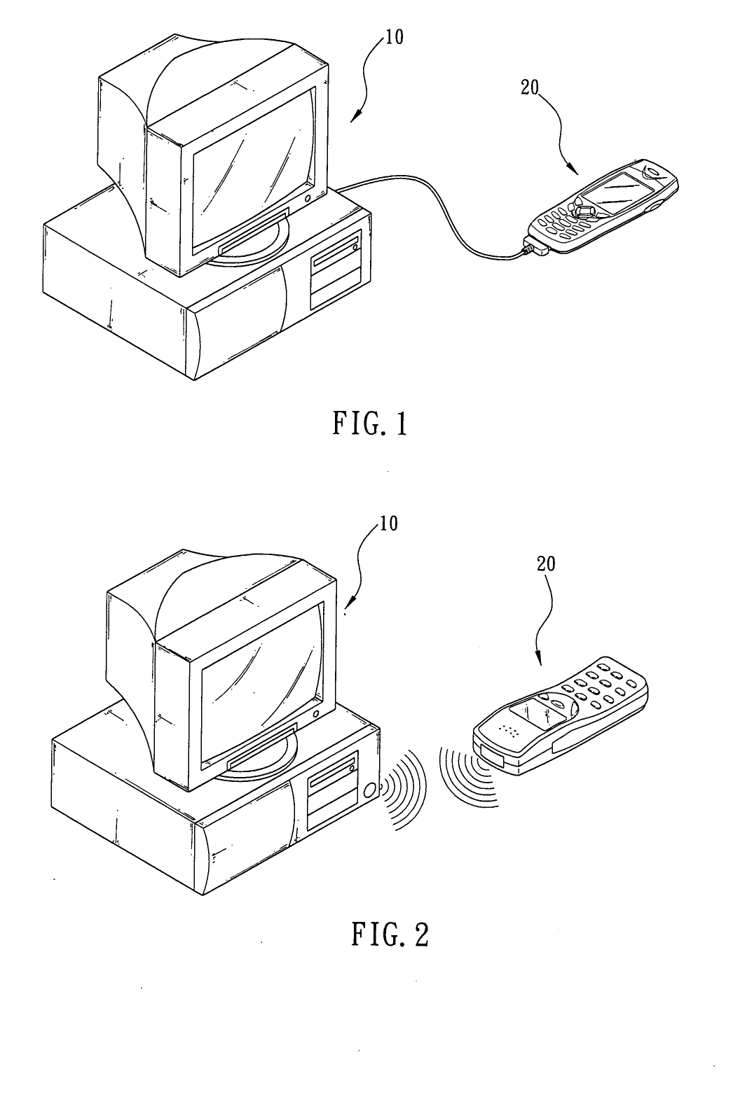

This invention focuses on the aforementioned problem to provide a “method of using an external electronic device on a fixed platform to operate short messages through a mobile communication device”. Please refer to FIGS. 1 and 2 for such method, which uses an external electronic device 10 (such as a personal computer, PC) on a fixed platform (such as an operating system for executing the program) to create and edit a short message. The electronic device 10 is connected to a mobile communication device 20 (such as a mobile phone) by a cable or a wireless (such as infrared) transmission method, so that a user can give a command to the external electronic device 10 to send the short message out through the control of the mobile communication device 20 according to the address of the target mobile communication device and the way of sending short messages specified in the short message in order to complete the process of sending a short message for one time. Thus, users can use the powerful data processing capability and the convenient way of editing text of the external electronic device 10 to operate a short message in a fast manner.

In this invention, the external electronic device 10 uses a fixed platform to control the mobile communication device 20 by means of an AT command. Such AT command is developed by the European Telecommunication Standard (ETS) for controlling the instruction set of the Group Special Mobile (GSM) mobile communication device 20. Such AT command provides a programmable interface for the mobile communication device 20 to implement the user's control on the mobile communication device 20.

In this invention, after the external electronic device 10 uses a fixed platform to edit the content of a short message and before the short message is sent to the electronic communication device 20 by a transmission method (cable or wireless) according to the ETS specification, the short message will be converted into a formatted string mode code such as a protocol description unit (PDU). Of course, codes of other modes can be used, but the PDU formatted string mode code is the most popular one of all.

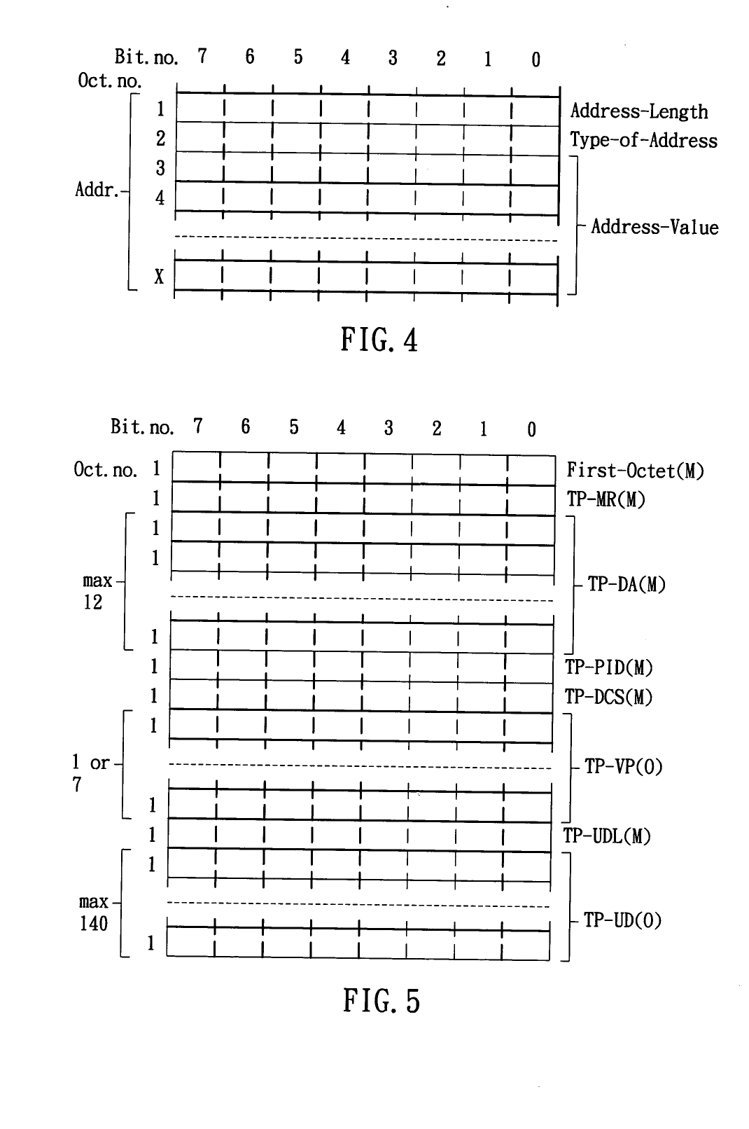

In the following preferred embodiment of this invention, the short message is sent in form of the PDU formatted string mode code, which is composed of two sections: the address of the short message service center (SMSC) and a transport protocol data unit (TPDU). Please refer to FIGS. 4, the address of the SMSC consists of 3 parts; an address length, a type of address, and an address value, wherein a part of the address length is the number of the short message service center, which differs according to the user's location. A command “AT+CSCA” in the AT instruction set is given to obtain the address of the short message center. The address length and address value will not be described in this embodiment, but we just need to fill them with the values of “09” and “81” respectively. Please refer to FIG. 5 showing an illustrative diagram of the transport protocol data unit (TPDU), of which the composition of the TPDU is more complicated. The TP-UD (0) (TP-User-Data) is the core of the TPDU, which is also the actual content of a short message being converted into the PDU formatted string mode code. As to a short message complying with the American Standard Code for Information Interchange (ASCII), its content is in the form of 7 bits (a series of 0 and 1) to define 128 possible characters. For example, a 2 bit short message (such as Chinese), a universal multiple-Octet code character set 2 (UCS2) is used as its format, which is located at a TP-Data Code Scheme (TP-DCS) on the PDU in order to indicate the format code. The value “00” indicates an ASCII short message, and the value “08” indicates a Chinese short message. The program will also automatically identify the type of short message according to the short message entered by users, and an appropriate numeric value will be filled in the location of TP-DCS.

Further, since the illustrative diagrams of the address of the SMSC and the TPDU belongs to an international specification, therefore they will not be further described here, and only the application of the core will be described in the preferred embodiment of this invention.

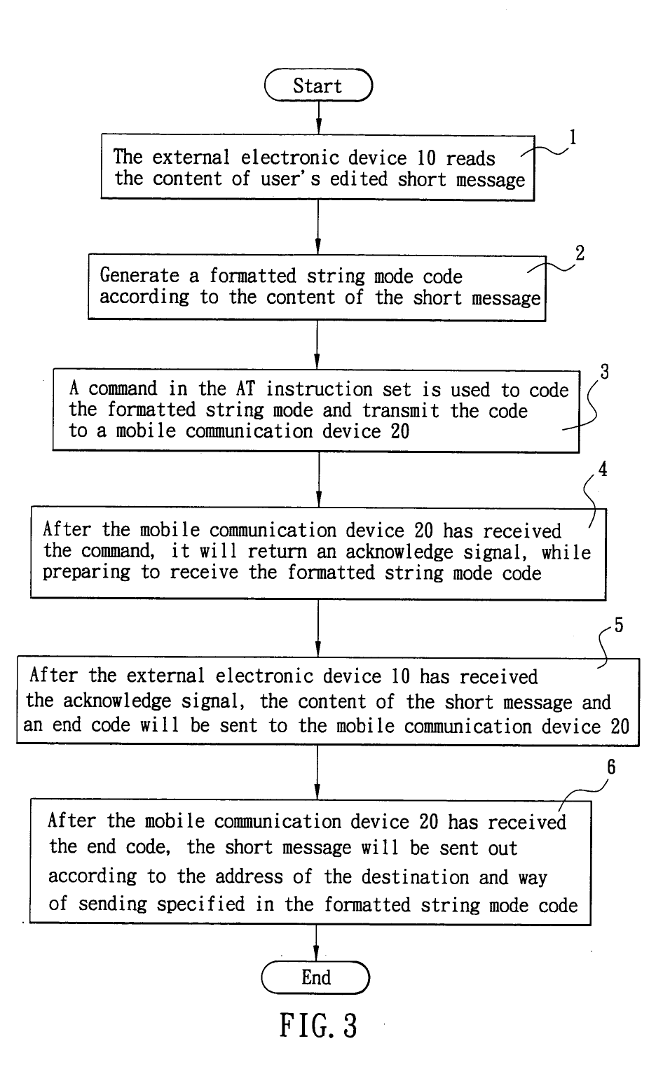

From the description above, when a user uses the external electronic device 10 to edit a short message on a fixed platform, the external electronic device 10 will control and execute the following steps. Please refer to FIG. 3.
(1) The external electronic device 10 reads the content of the short message edited by the user including the address of the mobile communication device to where the short message is sent;
(2) generating a formatted string mode code (such as a PDU formatted string) according to content of the edited short message and the address of the mobile communication device to where the short message is sent;
(3) using a SEND command “AT+CMGS=L” of the AT instruction set to code the formatted string mode and send the short message to a mobile communication device 20 via a transmission method (if the transmission method is by cable transmission, then the serial port (COM) on the mobile communication device 20 is used for the connection, where L stands for the length of the whole PDU formatted string mode code;
(4) returning an acknowledge signal “>” to the external electronic device 10 after the mobile communication device 20 has received the command “AT+CMGS=L”, and then getting ready to receive the PDU formatted string mode code;
(5) sending out the content of a short message in form of the PDU formatted string mode code from the external electronic device 10 to the mobile communication device 20 after the external electronic device 10 has received the return acknowledge signal “>”, and finally sending out an end code “1A”of the ASCII short message to indicate the end of the PDU formatted string mode code; and
(6) sending out the content of the short message according to the address of the mobile communication device to where the short message is sent and the way of sending, after the mobile communication device 20 has received the end code “1A” in order to complete the process of sending a short message for one time, and then ending the entire procedure.

While the invention has been described by means of specific embodiments, numerous modifications and variations could be made thereto by those skilled in the art without departing from the scope and spirit of the invention set forth in the claims.

1. A method of using external electronic device on fixed platform to operate short messages through mobile communication device, wherein when a user using an external electronic device on a fixed platform to edit a short message, the control and execution process of said electronic device comprising the steps of:
(a) reading the content of the short message edited by the user;
(b) generating a formatted string mode code according to the content of the edited short message and an address of a target mobile communication device;
(c) using a send command of a related instruction set to set a mobile communication device at the state of waiting for said formatted string;
(d) returning an acknowledge signal to said external electronic device and preparing to receive said formatted string mode code, after said mobile communication device receiving the returned acknowledge signal;
(e) sending the content of said short message in form of formatted string mode code to said mobile communication device after the returned acknowledge signal being received by said external electronic device, and then sending out an end code of said short message; and
(f) sending out the content of said short message according to the address of said target mobile communication device specified in the formatted string mode code and the way of sending in order to complete the process of sending a short message for one time, and then ending the entire process.

2. The method of using external electronic device on fixed platform to operate short messages through mobile communication device of claim 1, wherein said formatted string mode code is a PDU formatted string mode code, and said command in the related instruction set is a command “AT+CMGS=L” of an AT instruction set, of which L being the length of the whole PDU formatted string mode code.

3. The method of using external electronic device on fixed platform to operate short messages through mobile communication device of claim 1, wherein said transmission method is a cable transmission by connecting a serial port on said mobile communication device.

4. The method of using external electronic device on fixed platform to operate short messages through mobile communication device of claim 1, wherein said transmission method is a wireless transmission.

5. The method of using external electronic device on fixed platform to operate short messages through mobile communication device of claim 1, wherein said external electronic device is a personal computer.

6. The method of using external electronic device on fixed platform to operate short messages through mobile communication device of claim 1, wherein said mobile communication device is a mobile phone.
